(19) United States
(12) Patent Application Publication
(10) Pub. No.: US 2014/0131952 A1
(43) Pub. Date: May 15, 2014

(54) ADJUSTABLE FACE SEAL ASSEMBLY

(71) Applicant: CATERPILLAR GLOBAL MINING LLC, Oak Creek, WI (US)

(72) Inventors: Vanyo Nikolov Kirov, Cudahy, WI (US); Nicholas Dame, Kenosha, WI (US)

(73) Assignee: Caterpillar Global Mining LLC, Oak Creek, WI (US)

(21) Appl. No.: 13/677,848

(22) Filed: Nov. 15, 2012

(51) Int. Cl. F16J 15/16

(52) U.S. Cl. CPC F16J 15/16
USPC 277/306; 277/358

(57) ABSTRACT

An adjustable dynamic face seal assembly for an EWGU is provided. The adjustable dynamic face seal assembly includes a first seal ring having a first seal face and a second seal ring have a second seal face. The first seal ring is mounted in a first seal ring retainer, and the second seal ring is mounted in a second seal ring retainer. The adjustable dynamic face seal assembly also includes a first flexible seal element supported by the first seal ring and retained by the first seal ring retainer, and a second flexible seal element supported by the second seal ring and retained in the second seal ring retainer. Adjustment members are selectively insertable to provide a static seal at the sealing interface.

### TECHNICAL FIELD

The present disclosure relates generally to the field of face seals.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Large mobile equipment often has wheel motor assemblies, which are sometimes referred to as electrical wheel gear units (EWGU). Oil may leak from these EWGUs, especially when the mobile equipment is used in particularly severe conditions, such as conditions associated with mining. Oil leaks can create problems with the mobile equipment, causing the equipment to run less efficiently. For instance, oil leaks can cause premature wear to the equipment, leading to more frequent equipment replacement, and increased maintenance costs.

The present disclosure relates generally to the field of face seals (i.e. seals in which the sealing surfaces are normal to the axis of the seal). In addition to other applications, face seals are often used on the EWGUs of large mobile equipment. Face seals for EWGUs are typically used to protect the interior components of the wheel motor from potentially harmful elements, and also to prevent or reduce oil leaks. An example of a seal for a motor shaft can be found in U.S. patent application Ser. No. 12/701,744, filed Feb. 8, 2010, for “System and Method for Re-Building a Pump.”

EWGUs for mining trucks are often subject to particularly severe environmental conditions. As a result of these conditions, the EWGUs may not maintain the proper sealing pressure, and the EWGUs may leak oil or other fluid. Thus, EWGUs for mining trucks often utilize face seals to prevent or reduce oil leaks that result from the pressure and temperature changes within the environment. However, face seals may be applied to any wheel motor, and to any number of different trucks. Each truck usually has different load requirements and is subject to different operating conditions, such as temperature or elevation. Therefore, a wheel motor face seal should be able to adapt to different conditions, and should be able to provide a reliable seal to any wheel motor to which it is applied.

### SUMMARY

An embodiment of the present disclosure relates to an adjustable dynamic face seal assembly for an EWGU. The adjustable dynamic face seal assembly includes a first seal ring having a first seal face and a second seal ring having a second seal face. The first seal ring is disposed in a first seal ring retainer, and the second seal ring is disposed in a second seal ring retainer. The first seal ring and the first seal ring retainer are non-rotatable and the second seal ring and the second seal ring retainer are rotatable. The first seal ring and the second seal ring are positioned so that the first seal face and the second seal face define a sealing interface.

In this embodiment, the adjustable dynamic face seal assembly also includes a first flexible seal element supported on the first seal ring and retained by the first seal ring retainer, and a second flexible seal element supported on the second seal ring and retained by the second seal ring retainer. The first and second flexible seal elements provide an axial sealing pressure to the sealing interface between the first and second seal rings. The adjustable dynamic face seal assembly further includes adjustment members selectively insertable to adjust a gap between the first seal ring retainer and the second seal retainer, and thereby provide a static seal at the sealing interface between the first and second seal rings.

Another embodiment of the present disclosure relates to an EWGU for a vehicle. The EWGU includes a rotatable portion including a traction motor, a non-rotatable portion including a mounting flange configured to couple the traction motor to the vehicle, and at least one adjustable dynamic face seal assembly disposed between the rotatable portion and the non-rotatable portion. The adjustable dynamic face seal assembly includes a first seal ring retainer coupled to the non-rotatable portion and a second seal ring retainer coupled to the rotatable portion, the first seal ring retainer disposed adjacent to the second seal ring retainer and defining a gap therebetween. The adjustable dynamic face seal assembly also includes a first seal ring disposed at least partially within the first seal ring retainer and a second seal ring disposed at least partially within the second seal ring retainer.

In this embodiment, the first seal ring has a front surface and a back surface, the front surface defining a first seal face. The second seal ring has a front surface and a back surface, the front surface defining a second seal face, the first seal face disposed adjacent to the second seal face to define a sealing interface. The adjustable dynamic face seal assembly further includes a first flexible seal element disposed between the first seal ring and the first seal ring retainer, a second flexible seal element disposed between the second seal ring and the second seal ring retainer, and adjustment members selectively engagable with at least one of the first seal ring retainer and the second seal ring retainer for adjusting the gap.

Another embodiment of the present disclosure relates to a method of adjusting a dynamic face seal assembly to set the appropriate sealing pressure for the dynamic face seal assembly. The method includes determining the desired gap between two opposing face seal retainers, A_{desired}, based on the application of the dynamic face seal assembly, to provide appropriate sealing pressure, measuring the existing gap, A, at various positions around the circumference of the opposing face seal retainers, taking the average of the A measurements to yield an A_{avg} measurement, and if A_{avg} is different than the desired gap, A_{desired}, inserting or removing adjustment members to axially move at least one of the retainers so that the average gap, A_{avg}, is equal to the desired gap, A_{desired}.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 illustrates a mining truck in which the seals of the disclosed device are typically used, shown next to a full-sized sport utility vehicle.

FIG. 2 is a perspective view of a typical EWGU used in a mining truck.

FIG. 3 is a cutaway perspective view of the EWGU of FIG. 2.

FIG. 4 is a cross-section of an adjustable inboard seal assembly of the present disclosure, according to an exemplary embodiment.

FIG. 5 is a cross-section of an adjustable outboard seal assembly of the present disclosure, according to an exemplary embodiment

FIG. 6 is an end view of a shim used to adjust the seal pressure.

FIG. 7 is a side view of the shim shown in FIG. 6.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

The disclosed device is an adjustable dynamic face seal assembly for an EWGU. The seal assembly may be used to adjust the distance or gap between opposing seal housings or retainers to thereby set the appropriate sealing pressure for the particular seal assembly being used. In these embodiments, the gap is adjusted using a method that includes determining the desired gap between two opposing face seal retainers, and inserting or removing adjustment members, such as shims, to axially move at least one of the retainers to achieve the desired gap.

Referring to FIG. 1, a mining truck 10 is shown next to a full-sized sport utility vehicle 12, for the purpose of comparing the size of the two vehicles 10 and 12. Mining trucks 10 typically have a payload capacity of several hundred tons, and may operate in severe environmental conditions. The environmental and payload demands on mining trucks 10 may therefore exceed the demands placed on normal vehicles, such as vehicle 10. Accordingly, the construction and assembly of the components used in these mining trucks 10 must be designed and built to withstand these demands.

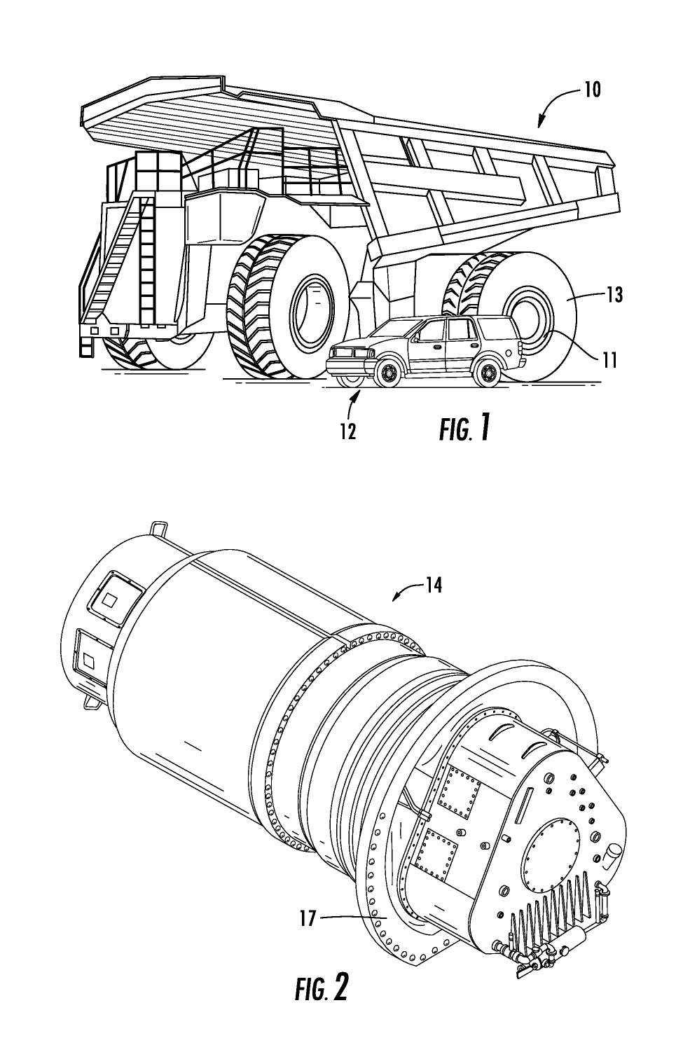

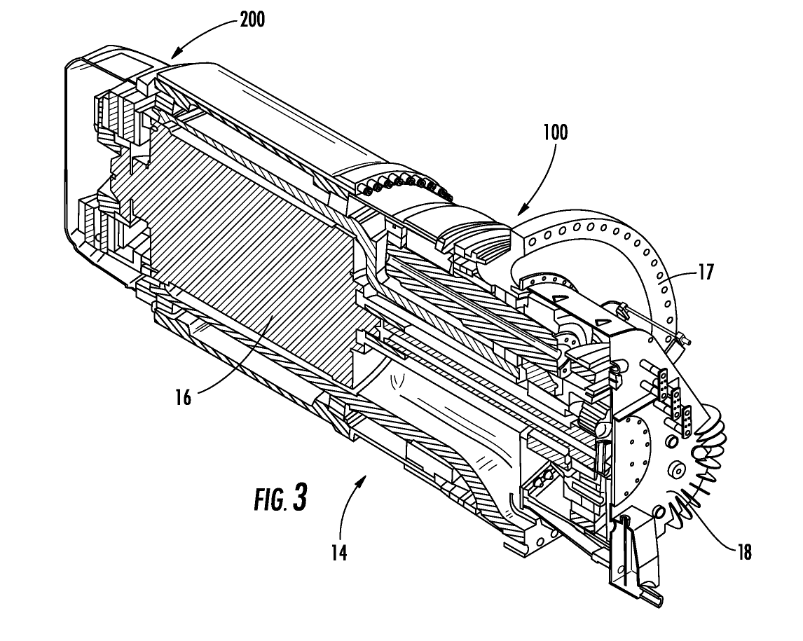

Referring now to FIG. 2, an EWGU 14 for a mining truck 10 is shown, according to an exemplary embodiment. The EWGU 14 is mounted to the truck structure with a mounting flange 17. As shown in FIG. 1, a hub 11 is then assembled to the EWGU 14, and tires 13 are mounted to the hub 11.

An EWGU 14 typically includes fluid seals, such as the face seal assemblies of the present disclosure, to prevent leakage at points where components of the assembly 14 meet. Face seal leaks or seal failures on EWGUs 14 may be detrimental to the associated equipment, leading to prolonged periods of equipment downtime to clean, repair, or otherwise maintain the equipment.

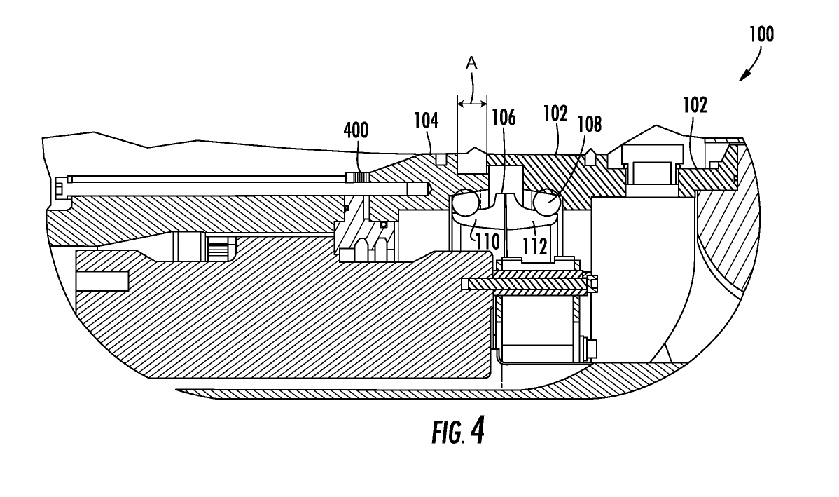

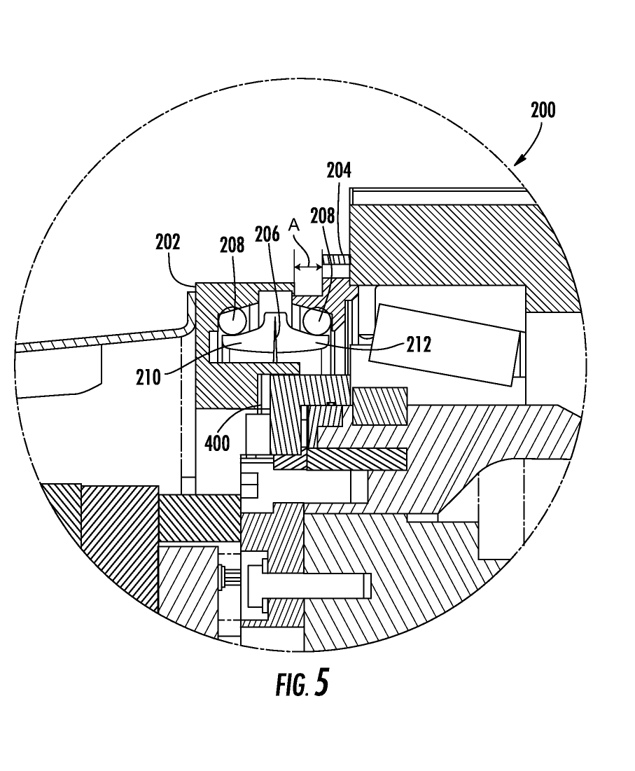

Referring now to FIG. 3, a cutaway perspective view of the EWGU of FIG. 2 is shown. In this exemplary embodiment, the EWGU 14 includes a traction motor 16, which may receive its electrical power from a high horsepower diesel engine (not shown) driving a traction alternator (not shown) and gearbox 18 driven by the traction motor. The EWGU 14 also includes both an inboard face seal assembly 100 and an outboard face seal assembly 200 (shown in further detail in FIGS. 4 and 5, respectively). The EWGU 14 may be mounted to the hub 11 by the mounting flange 17.

In exemplary embodiments, the EWGU 14 includes seal assemblies 100 and 200, which are intended to prevent oil leaks. Seal assembly 100 is positioned at an inboard location on the EWGU 14, and seal assembly 200 is positioned at an outboard location on the EWGU 14, as shown generally in FIG. 3. In exemplary embodiments, the seal assemblies 100 and 200 are mechanical face seals which are engineered for rotating applications in arduous environments. The seal assemblies 100 and 200 are configured to withstand wear and to prevent ingress of harsh and abrasive external media.

Still referring to FIG. 3, both the inboard seal assembly 100 and the outboard seal assembly 200 are adjustable, in exemplary embodiments. Sealing requirements are typically different at the inboard and outboard locations. Therefore, the seal assemblies 100 and 200 may be adjusted at the inboard and outboard locations to achieve the seal pressures necessary for adequate sealing for preventing leaks. In exemplary embodiments, one or more shims 400 (shown in FIG. 4) may be used to adjust the distance between components, so that the necessary seal pressure is maintained within the seal assemblies 100 and 200. However, in other exemplary embodiments, other materials may be used to adjust the assemblies 100 and 200, depending on the suitability for the particular application.

Referring now to FIG. 4, a cross-section of the inboard seal assembly 100 is shown, according to an exemplary embodiment. The inboard seal assembly 100 is shown as mounted within the EWGU 14. In this embodiment, the seal assembly 100 includes two seal rings 110 and 112. The seal rings 110 and 112 are made from cast iron, according to exemplary embodiments, and in particular may be made from a hard grey iron alloy. However, in other embodiments the seal rings 110 and 112 may be made of any other material suitable for the particular application. The seal rings 110 and 112 may also be fragile or brittle, and may be easily damaged in some embodiments.

The seal ring 112 is static, in exemplary embodiments, meaning that there is no relative motion between the mating surfaces being sealed. The seal ring 110 is configured to rotate, in exemplary embodiments, meaning that there is relative motion between the mating surfaces being sealed. Static seals are able to handle wider tolerances, rougher surface finishes, and higher pressure limits than dynamic, or rotating, seals.

Still referring to FIG. 4, the inboard seal assembly 100 also includes a fixed retainer 102 and a rotating retainer 104, in exemplary embodiments. In these embodiments, the two seal rings 112 and 110, each having a seal face disposed adjacent to each other, are mounted to the retainers 102 and 104, respectively, providing a seal interface 106. The seal rings 112 and 110 have a similar geometric contour in exemplary embodiments, although the seal rings 112 and 110 may be of any shape suitable for the application, in other embodiments.

According to the illustrated embodiment of FIG. 4, a dynamic o-ring 108 is the flexible sealing element in the seal assembly 100. However, referring to the seals 108 as an “o-ring” is not intended to limit the shape or cross-section of the seal 108 to a generally round shape. O-ring seals may have a cross-section that is square, hexagonal, X-shaped, U-shaped, having lobes of various shape or number, or any other geometric shape suitable for the application. Also, the o-ring 108 may be reinforced or not reinforced, coated or uncoated, or made from any materials as is suitable for dynamic sealing applications. Common o-ring materials may include, but are not limited to nitrile, fluorocarbon, neoprene, butyl, and silicone, but any other materials may be used.

Still referring to the illustrated embodiment of FIG. 4, the o-rings 108 are supported by the seal rings 112 and 110, and retained by the seal ring retainers 102 and 104. In these embodiments, the retainers 102 and 104 each include an angled surface, and the seal rings 112 and 110 also each include an angled surface. The angled surfaces on the retainers 102 and 104 are configured to compress the o-rings 108, generating a pressure on the o-rings 108. The o-rings 108 are configured to flex in response to the pressure from the retainers 102 and 104, which may generate a pressure on the angled surfaces of the seal rings 110 and 112. In exemplary embodiments, the pressure from the o-rings 108 on the angled surfaces of the seal rings 110 and 112 pushes the seal rings 110 and 112 toward each other, providing a fluid seal at the seal interface 106.

The seal ring 110 may rotate in exemplary embodiments, which may create a frictional torque against the seal ring 112. The o-rings 108 are intended to maintain axial sealing pressure on seal interface 106, and to thereby provide a seal between the seal rings 112 and 110. In exemplary embodiments, the o-rings 108 provide an appropriate pressure to the seal rings 112 and 110, forcing the rotating seal ring 110 to apply a frictional torque to seal ring 112, and thus to provide a fluid seal at interface 106.

Referring now to FIG. 5, a cross-section of the outboard seal assembly 200 is shown as mounted within the EWGU 14, according to an exemplary embodiment. The outboard seal assembly 200 is similar in structure to the inboard seal assembly 100. In exemplary embodiments, the seal assembly 200 includes two seal rings 210 and 212. The seal ring 210 may be static, and the seal ring 212 may be configured to rotate. In exemplary embodiments, the seal rings 210 and 212 are cast iron, and may be made of a hard grey iron alloy. In other embodiments, however, the seal rings 210 and 212 may be made of any other material suitable for the particular application. The seal rings 210 and 212 may also be fragile or brittle, and may be easily damaged.

Still referring to the illustrated embodiment of FIG. 4, the o-rings 208 are supported by the seal rings 210 and 212, and retained by the seal ring retainers 202 and 204. In these embodiments, the retainers 202 and 204 each include an angled surface, and the seal rings 210 and 212 also each include an angled surface. The angled surfaces on the retainers 202 and 204 are configured to compress the o-rings 208, generating a pressure on the o-rings 208. The o-rings 208 are configured to flex in response to the pressure from the retainers 202 and 204, which may generate a pressure on the angled surfaces of the seal rings 210 and 212. In exemplary embodiments, the pressure from the o-rings 208 on the angled surfaces of the seal rings 210 and 212 pushes the seal rings 210 and 212 toward each other, providing a fluid seal at the seal interface 206.

The seal ring 212 may rotate in exemplary embodiments, which may create a frictional torque against the seal ring 210. The o-rings 208 are intended to maintain axial sealing pressure on interface 206, and to thereby provide a static seal between the seal rings 212 and 210. In exemplary embodiments, the o-rings 208 provide an appropriate pressure to the seal rings 212 and 210, forcing the rotating seal ring 212 to apply a frictional torque to seal ring 210, and thus to provide a fluid seal.

Both inboard seal assembly 100 and outboard seal assembly 200 are configured so that the o-rings 108 and 208 exert pressure against the sealing surfaces, intended to seal the EWGU 14 from fluid leaks. Typically, the seal assemblies 100 and 200 may be sensitive to the pressure applied to them through the surrounding seal structure. Too much or too little pressure may lead to leaks in the EWGU 14. The seal pressure depends (at least in part) on a distance between the seal retainers 102 and 104, or seal retainers 202 and 204. This distance is influenced by the dimensional variations of the various parts used in the assembly 100 or 200.

In order to achieve the necessary sealing pressure, the gap between the mechanical face seal retainers, represented by distance, “A,” in FIGS. 4-5, must be properly set. The distance, A, to achieve the appropriate sealing pressure, or A_{desired}, is not the same in all applications. A_{desired} varies depending on the particular EWGU 14, and depending on the way the EWGU 14 is mounted within the associated mobile equipment. In exemplary embodiments, A_{desired} may be specified by a seal manufacturer and may be different for different applications. By way of example, A_{desired} may be approximately 22.5 mm, but may be greater or lesser in other embodiments.

When the EWGU 14 includes large components, such as in mining trucks, it may be difficult to achieve the correct distance, A_{desired,} by simply assembling the components. In these types of machinery, even if all parts are within the normal design tolerances, the accumulation of normal manufacturing deviations and tolerances, or “stackup”, may result in a distance, A, which does not provide an adequate seal pressure. When the stackup does not allow effective sealing, the result is a device which may leak oil and/or allow dirt and other debris to enter the EWGU 14, which may cause premature wear or failure.

The distance, A, may also vary depending on the particular EWGU 14, or the associated equipment. Accordingly, an adjustment at the seal assembly 100 or 200 is typically needed. In exemplary embodiments, an adjustment to the distance, A, is made by using one or more shims 400, typically ranging in thickness from 0.125 mm to 4.0 mm. However, in other embodiments, the shims 400 may be of any thickness suitable for the particular application.

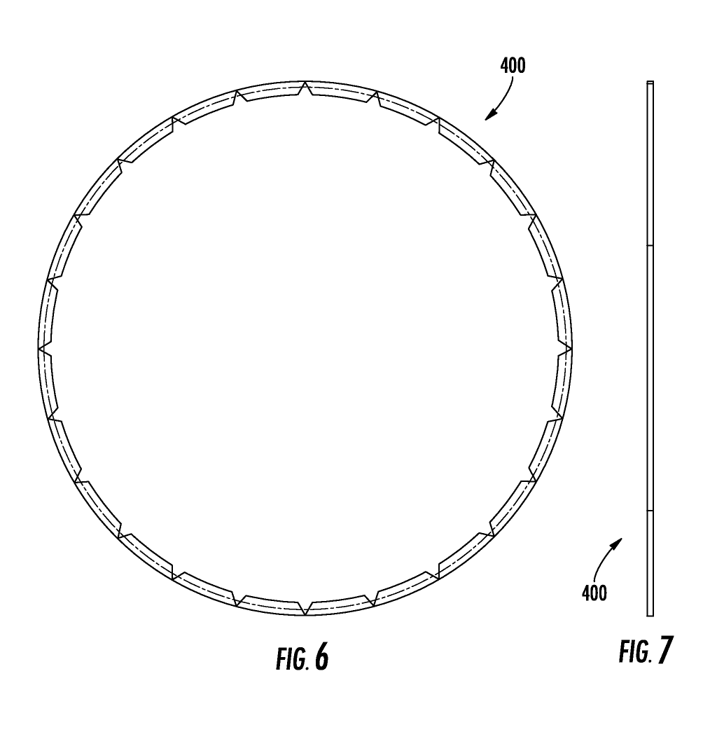

Referring now to FIGS. 6 and 7, a shim 400 is shown from a top view and a side view, respectively, according to an exemplary embodiment. The shim 400 is circular in shape, in exemplary embodiments, so that the shim 400 may be applied equally around the circumference of the seal assembly 100 or 200. However, in other embodiments the shim 400 may be of any shape suitable for the particular application.

As shown in FIG. 6, in exemplary embodiments, the shim 400 is formed by twenty-four equally spaced sections, extending along the circumference of the shim 400. Thus, when the shim 400 is applied to the seal assembly 100 or 200, the distance, A, is modified equally around the circumference of the seal assembly 100 or 200. However, the shim 400 may be formed in any manner necessary to suit the particular application, in other embodiments. As shown from the side view of FIG. 7, the shim 400 has a substantially uniform thickness, in exemplary embodiments. Again, the uniform thickness is intended to ensure that once the shim 400 is applied to the seal assembly 100 or 200, the distance, A, is modified equally around the circumference of the seal assembly 100 or 200. The shim 400 is intended to be provided in a variety of thicknesses to readily achieve the desired gap size. According to the illustrated embodiment, the shim 400 is generally circular to correspond with the circular sealing application.

The adjustable face seal assembly of the present disclosure is intended to set the correct sealing pressure by providing an adjustment at the seal assemblies 100 and 200, which may help to avoid oil leaks or contamination from the egress of dirt and debris that may be caused by tolerance stackup. As an example, in exemplary embodiments, the seal assembly 100 may be assembled and adjusted for proper sealing pressure by first positioning O-rings 108 onto seal retainers 102 and 104 to provide even face pressure on the sealing surface. The shims 400 are then positioned as needed and equally spaced between the seal retainers 102 and 104. The shims 400 are made from flat bar stock or from sheet stock in exemplary embodiments. However, the shims 400 may be made from metal or non-metal, or any other material suitable for the application, and the shims 400 do not have to be machined. The shims 400 are applied within the space shown on the seal assembly 100 in FIG. 4, and are intended to ensure the desired spacing, A_{desired}, between the retainers 102 and 104. Once enough shims 400 are applied to the assembly 100, and A_{desired} is i achieved, the parts may be secured. The same process may be used to adjust seal assembly 200 for proper sealing pressure.

In order to set A_{desired}, a measurement for distance, A, is recorded in several places substantially equally around the circumference of the seal assembly 100 or 200, according to one embodiment. The average of these measurements will yield an A_{avg} measurement. In exemplary embodiments, A_{desired} is a known distance and includes a tolerance provided by the seal manufacturer in order to provide the necessary sealing pressure to the seal assembly 100 or 200. In these embodiments, shims 400 may be added or removed from the seal assembly 100 or 200 until A_{avg} is within the range provided, A_{desired}. In other exemplary embodiments, the necessary sealing pressure may be known. In these embodiments, shims 400 may be added or removed from the seal assembly 100 or 200 until the necessary sealing pressure at the seal face 106 or 206 is achieved. The shims may cover substantially the entire circumference or may be provided as circular sectors.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It should be noted that the orientation of various elements may differ according to other exemplary embodiments, and that such variations are intended to be encompassed by the present disclosure.

It is also important to note that the construction and arrangement of the systems and methods for providing the adjustable face seal assembly as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed herein. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the various exemplary embodiments without departing from the scope of the present inventions.

### INDUSTRIAL APPLICABILITY

The disclosed adjustable face seal assembly may be utilized in any mobile equipment having wheel motors, including but not limited to mining equipment such as electrical mining trucks. The disclosed adjustable face seal assembly is intended to prevent or reduce oil leaks caused by seal failure. Oil leaks may cause the equipment to run less efficiently, and may lead to premature equipment failure. The adjustable face seal assembly of the present disclosure may therefore reduce equipment downtime due to premature wear, and may also reduce the amount of maintenance and cleaning costs normally associated with oil leaking on the equipment.

Conventional face seals are intended to prevent fluid leaks. However, conventional face seals are typically sensitive to pressure applied to them through the surrounding seal structure, especially in large equipment with potentially large gaps between components. Too much or too little pressure may lead to fluid leaks. The adjustable face seal assembly of the present disclosure utilizes adjustment members, through which the necessary pressure may be set during assembly. The adjustable face seal assembly of the present disclosure may therefore reduce or prevent oil leaks within a given application.

It will be apparent to those skilled in the art that various modifications and variations can be made to the disclosed adjustable face seal assembly. Other embodiments will be apparent to those skilled in the art from consideration of the specification and practice of the disclosed adjustable face seal assembly. It is intended that the specification and examples be considered as exemplary only, with a true scope being indicated by the following claims and their equivalents.

What is claimed is:

1. An adjustable dynamic face seal assembly for an EWGU, the adjustable dynamic face seal assembly comprising:
a first seal ring having a first seal face and a second seal ring having a second seal face;
the first seal ring disposed in a first seal ring retainer, and the second seal ring disposed in a second seal ring retainer;
the first seal ring and the first seal ring retainer being non-rotatable and the second seal ring and the second seal ring retainer being rotatable;
the first seal ring and the second seal ring positioned so that the first seal face and the second seal face define a sealing interface;
a first flexible seal element supported on the first seal ring and retained by the first seal ring retainer;
a second flexible seal element supported on the second seal ring and retained by the second seal ring retainer;
the first and second flexible seal elements providing an axial sealing pressure to the sealing interface between the first and second seal rings; and
adjustment members selectively insertable to adjust a gap between the first seal ring retainer and the second seal retainer, and thereby provide a static seal at the sealing interface between the first and second seal rings.

2. The adjustable dynamic face seal assembly of claim 1, wherein the first seal ring is configured to apply a frictional torque to the second seal ring through the sealing interface.

3. The adjustable dynamic face seal assembly of claim 1, wherein the first seal ring comprises a first angled surface, and the second seal ring comprises a second angled surface, the first flexible sealing element compressed between the first angled surface and the first seal ring retainer, and the second flexible sealing element compressed between the second angled surface and the second seal ring retainer.

4. The adjustable dynamic face seal assembly of claim 1, wherein the adjustment members comprise one or more shims.

5. The adjustable dynamic face seal assembly of claim 4, wherein the shims are equally spaced around the circumference of the EWGU.

6. The adjustable dynamic face seal assembly of claim 4, wherein the shims comprise a metallic material.

7. The adjustable dynamic face seal assembly of claim 4, wherein the shims comprise a non-metallic material.

8. The adjustable dynamic face seal assembly of claim 1, wherein the first and second flexible seal elements are o-ring seals.

9. The adjustable dynamic face seal assembly of claim 1, wherein the first and second seal rings comprise hard iron alloy.

10. The adjustable dynamic face seal assembly of claim 1, wherein the sealing interface is configured to prevent ingress of harsh and abrasive external media.

11. An EWGU for a vehicle, comprising:
a rotatable portion including a traction motor;
a non-rotatable portion including a mounting flange configured to couple the traction motor to the vehicle;
at least one adjustable dynamic face seal assembly disposed between the rotatable portion and the non-rotatable portion, comprising:
a first seal ring retainer coupled to the non-rotatable portion and a second seal ring retainer coupled to the rotatable portion, the first seal ring retainer disposed adjacent to the second seal ring retainer and defining a gap therebetween;
a first seal ring disposed at least partially within the first seal ring retainer and a second seal ring disposed at least partially within the second seal ring retainer;
the first seal ring having a front surface and a back surface, the front surface defining a first seal face;
the second seal ring having a front surface and a back surface, the front surface defining a second seal face, the first seal face disposed adjacent to the second seal face to define a sealing interface;
a first flexible seal element disposed between the first seal ring and the first seal ring retainer and a second flexible seal element disposed between the second seal ring and the second seal ring retainer; and
adjustment members selectively engagable with at least one of the first seal ring retainer and the second seal ring retainer for adjusting the gap.

12. The EWGU of claim 11, wherein the first flexible seal element exerts a force against the back surface of the first seal ring and the second flexible seal element exerts a force against the back surface of the second seal ring, to create a pressure at the sealing interface between the first and second seal faces.

13. The EWGU of claim 11, wherein adjustment of the gap with the adjustment members adjusts the pressure at the sealing interface.

14. The EWGU of claim 11, wherein the back surfaces of the first and second seal rings each define an angled surface, and the first flexible sealing element is compressed between the angled surface on the first seal ring and the first seal ring retainer, and the second flexible sealing element is compressed between the angled surface on the second seal ring and the second seal ring retainer.

15. The EWGU of claim 11, wherein the EWGU includes at least two adjustable dynamic face seal assemblies, an inboard adjustable dynamic face seal assembly positioned at an inboard location, and an outboard adjustable dynamic face seal assembly positioned at an outboard location.

16. The EWGU of claim 11, wherein the adjustment members comprise one or more shims.

17. The EWGU of claim 11, wherein the shims comprise a metallic material.

18. The EWGU of claim 11, wherein the first and second seal rings comprise a hard iron alloy.

19. A method of adjusting a dynamic face seal assembly to set the appropriate sealing pressure for the dynamic face seal assembly, the method comprising:
determining the desired gap between two opposing face seal retainers, A_{desired}, based on the application of the dynamic face seal assembly, to provide appropriate sealing pressure;
measuring the existing gap, A, at various positions around the circumference of the opposing face seal retainers;
taking the average of the A measurements to yield an A_{avg} measurement; and
if A_{avg} is different than the desired gap, A_{desired}, inserting or removing adjustment members to axially move at least one of the retainers so that the average gap, A_{avg}, is equal to the desired gap, A_{desired}.

20. The method of claim 19, wherein the adjustment members comprise one or more shims.
